(19) United States
(12) Patent Application Publication
(10) Pub. No.: US 2009/0204273 A1
(43) Pub. Date: Aug. 13, 2009

(54) COMPUTER SYSTEM AND METHOD FOR DETERMINING THE IMPACT OF AN EARTHQUAKE EVENT

(75) Inventors: Albert Otto SELIUS, Larchmont, NY (US); Maria Giovanna Guatteri, New York, NY (US)

Correspondence Address: OBLON, SPIVAK, MCCLELLAND MAIER & NEUSTADT, P.C., 1940 DUKE STREET, ALEXANDRIA, VA, 22314, US

(73) Assignee: Swiss Reinsurance Company, Zuerich (CH)

(21) Appl. No.: 12/029,760

(22) Filed: Feb. 12, 2008

(51) Int. Cl. G05D 3/20

(52) U.S. Cl. 700/302

(57) ABSTRACT

For determining the impact of an earthquake event, received and stored (S1) in a computer is location information associated with geographic locations. Moreover, received (S3) via a communications network from an earthquake data server is regional intensity data, indicative of ground shaking intensity caused at the geographic locations. An average damage expected at the geographic locations is determined (S4) as a function of the ground shaking intensity. Weighting factors are determined based on population numbers or risk values, and stored (S22) assigned to the geographic locations. An earthquake index, indicative of the impact of the earthquake event, is determined (S5) by adding up the damage expected at the geographic locations, the damage expected at each geographic location being weighted with the weighting factor assigned to the respective geographic location. For example, the earthquake index is used to determine the financial payout for a financial instrument associated with the geographic locations.

### FIELD OF THE INVENTION

The present invention relates to a computer system and a method for determining the impact of an earthquake event. Specifically, the present invention relates to a computer system and a computer-implemented method for determining the impact of an earthquake event on specific geographical locations.

### BACKGROUND OF THE INVENTION

Determining the regional impact of earthquake events is useful for getting a measure for direct and indirect regional losses from physical damages and interruptions caused by the earthquake events. Determining earthquake indices that are indicative of the regional impact of the earthquake events makes it possible to inform interested parties in a standardized fashion about the effect of earthquake events on specific geographic locations, e.g. defined geographic areas such as cities or countries or other populated areas. For example, the impact of a specific earthquake event on one or more geographic locations is indicated by an earthquake index. Based on earthquake indices, it is also possible to compare and analyze the regional impact of earthquake events over different periods of time. This is useful, not only when describing indices for actual historical events, but also when projecting future shifts of indices for given specific scenario cases, e.g. a scenario with hazard activity changes, or exposure/risk changes, which then can be used when building a current risk mitigation strategy. Furthermore, earthquake indices which indicate the regional impact of earthquake events make it possible to define structured financial instruments. For instance, payment based on predetermined trigger, payout pattern, and indexed loss amount would provide better transparency, smoother settlement, and more flexible coverage for clients than typical traditional insurance products. A structured regional and market parametric indices product can offer a client flexible risk transfer solutions for given client specific needs, such as portfolio location and risk types, and amount not only through a tailor-made product but also a combination of such standard and more reliable products. Patent applications JP 2003162641 and JP 2005158081 describe the computer-aided design of financial derivatives that are based on earthquakes. According to JP 2003162641 and JP 2005158081 a first derivative is based on the risk of an earthquake damage at the site of a target facility, primarily measured by the observed peak ground acceleration or peak ground velocity; a second derivative is based on the risk that an observation of peak ground acceleration or peak ground velocity across a predefined region affects more than a certain percentage of this region. The third derivative is based on the risk that an earthquake with a magnitude equal or higher than a given value occurs within a predefined target region. The seismic measurement values according to JP 2003162641 and JP 2005158081 are based on the peak ground acceleration (PGA) or peak ground velocity (PGV) values determined for the earthquake events.

### SUMMARY OF THE INVENTION

It is an object of this invention to provide an alternative computer system and an alternative computer-implemented method for determining the impact of an earthquake event. In particular, it is an object of the present invention to provide a computer system and a computer-implemented method for determining a parametric earthquake index, based on scientific seismic measurement values having a correlation with earthquake damages. It is a further object of the present invention to provide a computer system and a computer-implemented method for determining the impact of an earthquake event on a plurality of geographic locations that are not necessarily adjacent. It is yet a further object of the present invention to provide a computer system and a computer-implemented method for determining an earthquake index suitable for defining structured financial instruments related to a plurality of geographic locations that are not necessarily adjacent.

According to the present invention, these objects are achieved particularly through the features of the independent claims. In addition, further advantageous embodiments follow from the dependent claims and the description.

According to the present invention, the above-mentioned objects are particularly achieved in that, for determining the impact of an earthquake event, received and stored in a computer system is location information associated with geographic locations. Received from an earthquake data server via a communications network is regional intensity data, indicative of ground shaking intensity caused at the geographic locations by the earthquake event. An average damage, expected at the geographic locations, is determined as a function of the ground shaking intensity. An earthquake index, indicating the impact of the earthquake event, is determined by adding up the damage expected at the geographic locations, whereby the damage expected at each geographic location is weighted with a weighting factor assigned to the respective geographic location. For example, the earthquake index is used to determine the financial payout for a financial instrument associated with the geographic locations. For example, the geographic locations are defined in a country-wide or state-wide area, or in another specifically defined geographical area such as the San Francisco Bay Area or the Los Angeles metropolitan area.

In a preferred embodiment, the weighting factors are based on population numbers associated with the geographic locations.

In a further embodiment, the location information relates to a country and the geographic locations are cities located in this country. The regional intensity data indicates the ground shaking intensity caused in these cities. The weighting factors are based on population numbers of these cities, and the earthquake index indicates the impact of the earthquake event on the country's cities.

In another embodiment, the interface module is further configured to receive risk values associated with the geographic locations. Each of the risk values indicates a property value that is at risk in the respective geographic location. The weighting factors are determined based on the risk values associated with the geographic locations.

In an alternative embodiment, the location information designates the earth and the geographic locations are the populated areas of the earth. The regional intensity data indicates the ground shaking intensity caused in the populated areas. The damage is determined as a set of population numbers, whereby each population number in the set indicates the number of people exposed to one of several defined levels of ground shaking intensity in the populated areas. The weighting factors are based on the defined levels of ground shaking intensity. The earthquake index is determined by adding up the number of people exposed in the populated areas to the defined levels of ground shaking intensity, whereby the number of people is in each case weighted with the respective weighting factor. The earthquake index indicates the impact of the earthquake event on the earth's populated areas.

In a further aspect of this invention, provided is a computer system and a computer-implemented method for determining the impact of an earthquake event by receiving via a communications network from an earthquake data server regional intensity data, indicative of ground shaking intensity caused by the earthquake event in populated areas; determining a damage expected as a set of population numbers, each population number in the set indicating the number of people exposed to one of several defined levels of ground shaking intensity in the populated areas; determining weighting factors based on the defined levels of ground shaking intensity; and determining an earthquake index indicative of the impact of the earthquake event, by adding up the number of people exposed in the populated areas to the defined levels of ground shaking intensity, the number of people being in each case weighted with the respective weighting factor.

In addition to a computer system and a computer-implemented method for determining the impact of an earthquake event on, the present invention also relates to a computer program product including computer program code means for controlling one or more processors of a computer system such that the computer system performs the proposed method, particularly, a computer program product including a computer readable medium containing therein the computer program code means.

### BRIEF DESCRIPTION OF THE DRAWINGS

The present invention will be explained in more detail, by way of example, with reference to the drawings in which:

FIG. 1 shows a block diagram illustrating schematically an exemplary configuration of a computer system for practicing embodiments of the present invention, the computer system being connected to an earthquake data server.

FIG. 2 shows a flow diagram illustrating an example of a sequence of steps executed for determining the impact of an earthquake event.

FIG. 3 shows a flow diagram illustrating a further example of a sequence of steps executed for determining the impact of an earthquake event.

FIG. 4 shows a flow diagram illustrating another example of a sequence of steps executed for determining the impact of an earthquake event.

FIG. 5 shows an exemplary distribution of weighting factors in a geographical area.

### DETAILED DESCRIPTION OF THE PREFERRED EMBODIMENTS

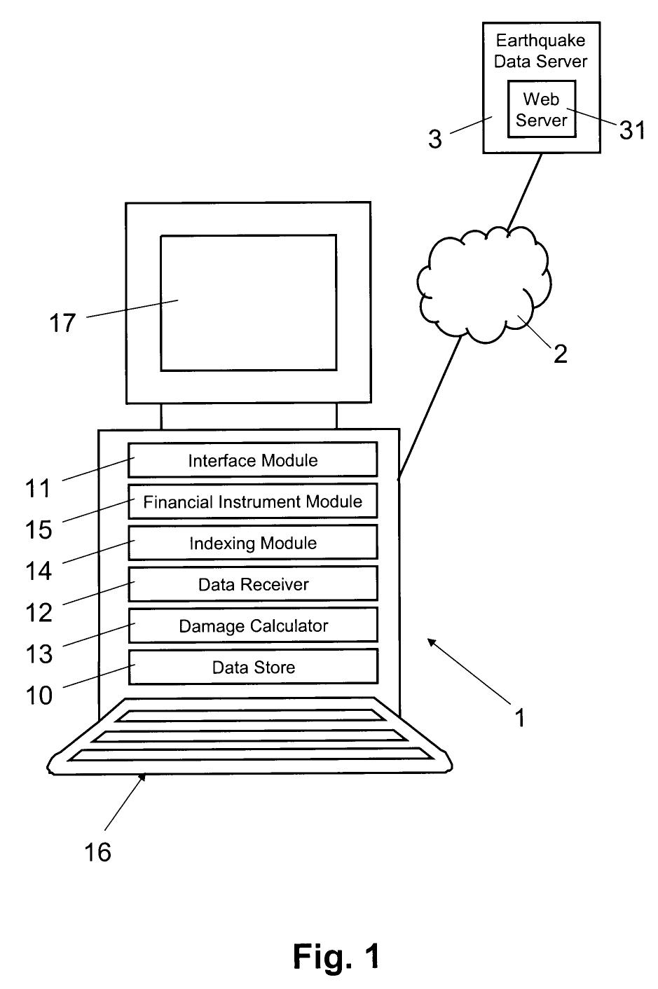

In FIG. 1, reference numeral 1 refers to a computer system for determining the impact of an earthquake event. Computer system 1 includes at least one computer with at least one processor. Computer system 1 also includes a display 17 and operating elements 16 such as a keyboard, and/or a computer mouse or another pointing device. As illustrated schematically in FIG. 1, in addition, computer system 1 includes a data store 10 and multiple functional modules, namely an interface module 11, a data receiver 12, a damage calculator 13, an indexing module 14, and a financial instrument module 15. The functional modules are implemented preferably as programmed software modules stored on a computer readable medium, connected fixed or removable to the processor(s) of computer system 1. One skilled in the art will understand, however, that the functional modules can also be implemented fully or in part by means of hardware.

Data store 10 is implemented as a data file, e.g. a structured data file or an electronic data spreadsheet, as a data table within a computer program, or as a database, e.g. a relational database including a database management system (DBMS). Data store 10 includes data structures and data elements representing weighting factors assigned to geographic locations. The geographic locations are defined preferably by coordinates (longitude, latitude), and/or by location names, such as city and/or country names.

As is illustrated in FIG. 1, computer system 1 is connected via a telecommunications network 2 to an earthquake data server 3. Telecommunications network 2 includes a wired or wireless network, e.g. the Internet, a GSM-network (Global System for Mobile Communication), an UMTS-network (Universal Mobile Telecommunications System) and/or a WLAN (Wireless Local Region Network), and/or dedicated point-to-point communication lines. The earthquake data server 3 comprises one or more computers connected to the telecommunications network 2. Preferably, earthquake data server 3 comprises a web server 31 configured to provide to computer system 1 regional intensity data via telecommunications network 2, e.g. via IP (Internet Protocol) and HTTP (Hypertext Transfer Protocol). The regional intensity data indicates the ground shaking intensity caused at specific geographic locations by an actual earthquake event. The regional intensity data is received at computer system 1 by data receiver 12. For example, data receiver 12 comprises a conventional web browser such as Microsoft's Internet Explorer, or Firefox by the Mozilla Foundation.

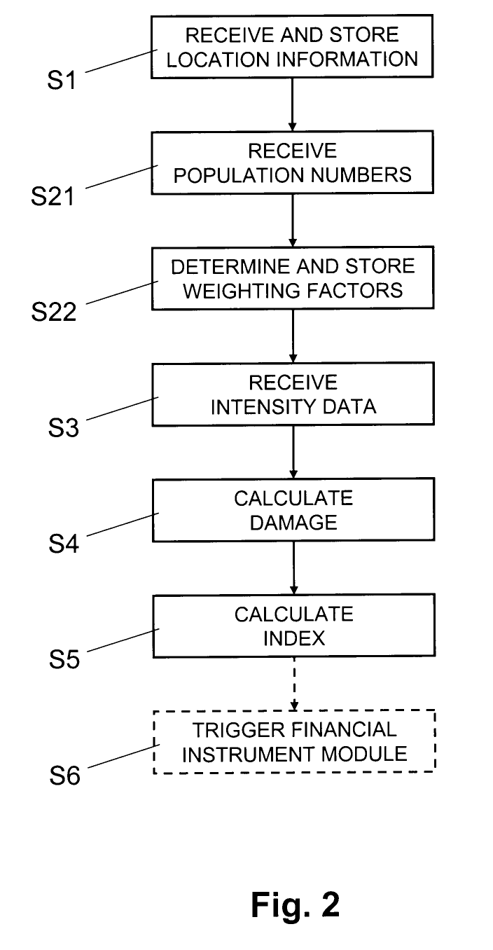

In the following paragraphs, the functionality of the functional modules as well as possible steps for determining the impact of an earthquake event are described with reference to FIGS. 2, 3 and 4.

In step S1, interface module 11 receives from a user of computer system 1 location information associated with geographic locations. For example, the location information is received as coordinates, postal code or address, and/or city and/or country names entered through one or more data entry fields or selected from a graphic map shown on display 17.

In step S21, data receiver 12 retrieves population numbers indicating the population size of the geographic locations defined in step S1. For example, the population numbers are retrieved as LandScan Dataset files publicly available over the Internet. The LandScan Dataset comprises a worldwide population database compiled on a 30″×30″ latitude/longitude grid. Census counts (at sub-national level) are apportioned to each grid cell based on likelihood coefficients, which are based on proximity to roads, slope, land cover, night time lights, and other information. LandScan has been developed as part of the Oak Ridge National Laboratory (ORNL) Global Population Project for estimating ambient populations at risk. In an embodiment, the population data is provided with day-time dependent population numbers.

In step S22, indexing module 14 determines weighting factors for the geographic locations defined in step S1 based on the respective population numbers. For example, the weighting factors are based on day-time dependent population numbers considering the actual time of the respective earthquake event. The weighting factors are stored in data store 10, respectively assigned to the geographic locations. The population numbers or the weighting factors, respectively, are kept fixed for the duration of a contract (e.g. one, two or five years) associated with the earthquake index. Table 1 illustrates an example with multiple geographic locations Z1, Z2 defined by coordinates (X1, Y1) and (X2, Y2), associated with weighting factors w₁ and w₂, respectively.

TABLE 1

| | Weighting |
|---|---|
| Location | Factor |
| Z1 (X1, Y1) | w₁ |
| Z2 (X2, Y2) | w₂ |
| . . . | . . . |

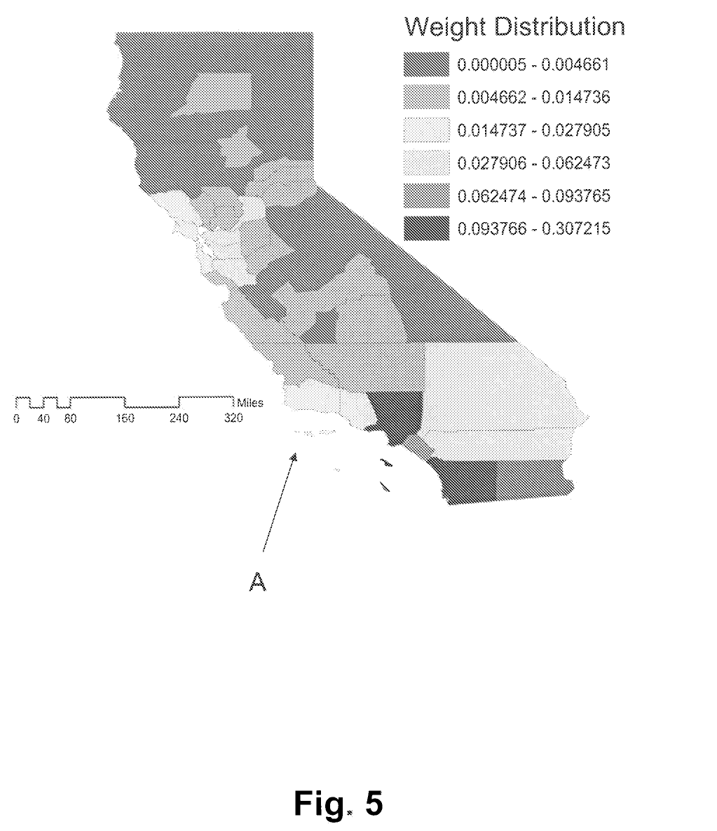

FIG. 5 illustrates an example of the weight distribution in geographical area A. As can be seen in FIG. 5, the geographical area A is divided into multiple sub-areas having different weight ranges based on regional population numbers [0.000005-0.004661], [0.004662-0.014736], [0.014737-0.027905], [0.027906-0.062473], [0.062474-0.093765], and [0.093766-0.307215].

In step S3, data receiver 12 receives from the earthquake data server 3 via communications network 2 the intensity data indicating the ground shaking intensity caused by an actual earthquake event at the geographic locations defined in step S1. For example, the regional intensity data is retrieved as (ground shaking) intensity footprints from ShakeMap provided over the Internet by USGS (U.S. Geological Survey). ShakeMap is a product of the U.S. Geological Survey Earthquake Hazards Program in conjunction with regional seismic network operators. ShakeMap sites provide near-real-time maps of ground motion and shaking intensity following significant earthquakes. The intensity data indicating the ground shaking intensity caused by an actual earthquake event at the geographic locations is stored respectively assigned to the defined geographic locations. For example, the intensity is indicated by intensity levels I, II-III, IV, V, VI, VII, VIII, IX and X.

In step S4, damage calculator 13 determines the average damage expected at the defined geographic locations as a function of the ground shaking intensity (levels) measured at the respective geographic locations. Preferably, the expected damage is indicated by a percentage value. Table 2 illustrates an example with multiple geographic locations Z1, Z2 associated with measured intensity levels VI and VII, and expected damages of 0.5% and 1%, respectively.

TABLE 2

| Location | Intensity | Damage |
|---|---|---|
| Z1 (X1, Y1) | VI | 0.5% |
| Z2 (X2, Y2) | VII | 1% |
| . . . | . . . | . . . |

In step S5, indexing module 14 determines an earthquake index I_{EQ} for the geographic locations Z1 specified in step S1 based on the respective weighting factors wᵢ and the damages Dᵢ determined in step S4. Preferably, the earthquake index I_{EQ} is calculated by adding up the weighted damages for the geographical locations Zᵢ:

$${I}_{EQ} = {\sum }_{i} {w}_{i} {D}_{i} .$$

In an embodiment, the location information received in step S1 relates to a country (or state) and the geographic locations are cities located in this country (or state). Correspondingly, the regional intensity data indicates the ground shaking intensity caused in these cities and the weighting factors are based on population numbers of these cities. Accordingly, the earthquake index is implemented as a country (or state) specific index indicating the impact of the earthquake event on the country's (or state's) cities.

Alternatively, the earthquake index indicates the number of locations with a damage level exceeding a defined severity threshold.

In optional step S6, indexing module 14 triggers the financial instrument module 15. The financial instrument module 15 determines for a financial instrument (financial derivative) associated with the geographic locations a financial payout based on the earthquake index.

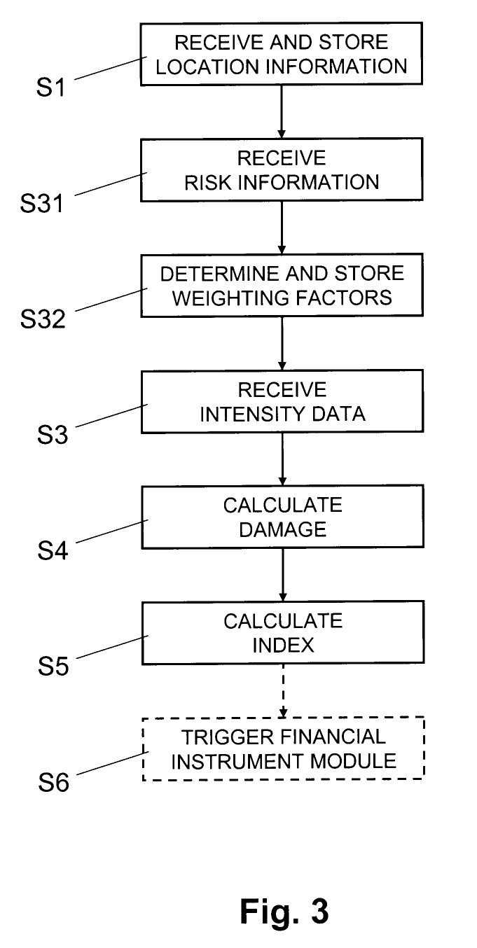

FIG. 3 illustrates a further example of a sequence of steps executed for determining the impact of an earthquake event. In FIG. 3, reference numerals S1, S3, S4, S5 and S6 refer to steps executed by interface module 11, data receiver 12, damage calculator 13, indexing module 14 and the financial instrument module 15, as outlined above with reference to FIG. 2.

In step S31, interface module 11 receives from a user of computer system 1 risk information associated with the geographic locations defined in step S1. For example, the risk information includes for the respective geographic locations in each case a risk value and an associated risk type. Each risk value defines for one of the defined geographic locations a property value which is at risk in the respective geographic location. For example, the risk information is received as property or insurance values associated with buildings and/or other property associated with a portfolio for the respective geographic location. The risk type defines the type of object associated with the portfolio for the respective geographic location, e.g. offices, commercial retails, warehouse, etc. For example, the risk information is entered through one or more data entry fields or specification of one or more data files. Table 3 illustrates an example with multiple geographic locations Z1, Z2, Z3 defined by coordinates (X1, Y1), (X2, Y2) or (X3, Y3), respectively, associated with risk types, and risk values. As can be seen in Table 3, in a preferred embodiment, there are different damage functions F1, F2, F3 associated with the different risk tapes.

TABLE 3

| | | | Damage | Weighting |
|---|---|---|---|---|
| Location | Risk Type | Risk Value | Function | Factor |
| Z1 (X1, Y1) | Offices | $20 Mio | F1 | 20% |
| Z2 (X2, Y2) | Commercial | $50 Mio | F2 | 50% |
| | retail | | | |
| Z3 (X3, Y3) | Warehouse | $25 Mio | F3 | 25% |

In step S32, indexing module 14 determines weighting factors for the geographic locations defined in step S1 based on the risk values. The weighting factors are stored in data store 10, respectively assigned to the geographic locations (see Table 3). The risk values or the weighting factors, respectively, are kept fixed for the duration of a contract associated with the earthquake index.

In step S4, damage calculator 13 determines the average damage expected at the defined geographic locations based on the respective measured ground shaking intensity (levels) using preferably a damage function F1, F2, F3 dependent on the risk type associated with the respective geographic location.

In step S5, based on the weighted damages, indexing module 14 determines the earthquake index I_{EQ} for the geographic locations Zᵢ specified in step S1, using the respective risk value based weighting factors wᵢ. Alternatively, the earthquake index indicates the number of locations with shaking intensity or damage level exceeding a defined severity threshold.

In optional step S6, indexing module 14 triggers the financial instrument module 15 as described above with reference to FIG. 2.

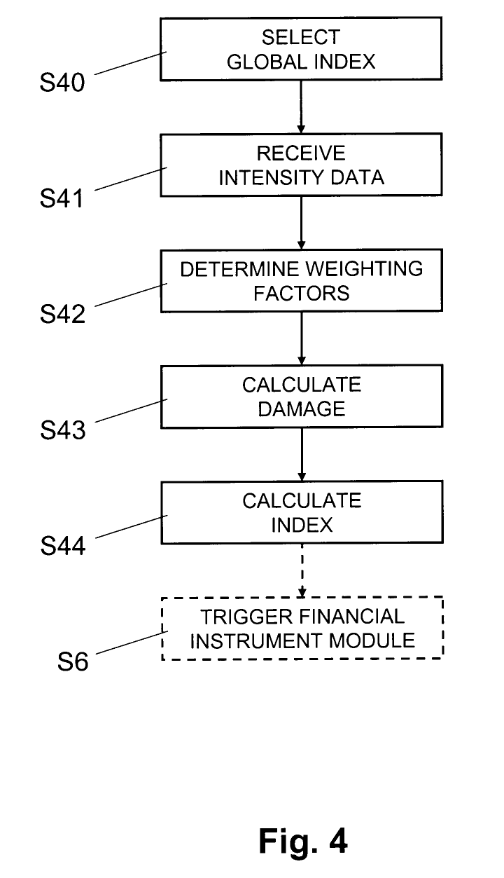

FIG. 4 illustrates another example of a sequence of steps executed for determining the impact of an earthquake event.

In step S40, interface module 11 receives from a user of computer system 1 a signal or instruction for selecting a global index. For example, the selection is made through a pull down menu, check box, or a data entry field shown on display 17. By selecting the global index, the location information relates to the earth and the geographic locations are the populated areas of the earth.

In step S41, data receiver 12 receives from the earthquake data server 3 via communications network 2 the intensity data indicating the ground shaking intensity caused by an actual earthquake event, as described above with reference to FIG. 2. The local intensity data relates to the populated areas impacted by the earthquake event, e.g. populated areas having an intensity level of at least level VI. For example, the population numbers are retrieved over the Internet from the PAGER system (Prompt Assessment of Global Earthquakes for Response) provided by the U.S. Geological Survey (USGS). The PAGER system is an automated system which monitors the U. S. Geological Survey's near-real-time detections of domestic and global earthquakes and rapidly assesses the number of people, cities, and regions exposed to severe shaking by an earthquake.

In Step S42, indexing module 14 determines the weighting factors for the impacted areas based on the defined levels of ground shaking intensity. The weighting factors are stored in data store 10, respectively assigned to the impacted geographic locations. Table 4 illustrates an example of intensity levels and associated weighting factors.

TABLE 4

| Intensity | Weighting |
|---|---|
| Level | Factor |
| VI | 10% |
| VII | 20% |
| VIII and | 70% |
| above | |

In step S43, damage calculator 13 determines the average damage expected at the impacted areas based on the population numbers associated with the respective geographical areas, i.e. the population numbers exposed to the respective intensity levels. In a preferred embodiment, day-time dependent population numbers are used for determining the expected average damage.

In step S44, indexing module 14 determines the global earthquake index I_{GEQ} based on the weighting factors wⱼ determined in step S42 and the damages Dⱼ determined in step S43. Preferably, the earthquake index I_{GEQ} is calculated by adding up the weighted damages for the impacted areas Zⱼ:

$${I}_{GEQ} = {\sum }_{j} {w}_{j} {D}_{j} .$$

In optional step S6, indexing module 14 triggers the financial instrument module 15 as described above with reference to FIG. 2.

The foregoing disclosure of the embodiments of the invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents. Specifically, in the description, the computer program code has been associated with specific software modules, one skilled in the art will understand, however, that the computer program code may be structured differently, without deviating from the scope of the invention. Furthermore, the particular order of the steps set forth in the specification should not be construed as limitations on the claims.

1. A computer system for determining an impact of an earthquake event, the system comprising:
an interface module configured to receive and store location information associated with geographic locations;
a data receiver configured to receive via a communications network from an earthquake data server regional intensity data, indicative of ground shaking intensity caused at the geographic locations by the earthquake event;
a damage calculator configured to determine an average damage expected at the geographic locations as a function of the ground shaking intensity;
a data store including weighting factors assigned to the geographic locations; and
an indexing module configured to determine an earthquake index indicative of the impact of the earthquake event, by adding up the damage expected at the geographic locations, the damage expected at each geographic location being weighted with the weighting factor assigned to the respective geographic location.

2. The system according to claim 1, wherein the weighting factors are based on population numbers associated with the geographic locations.

3. The system according to claim 1, wherein the location information relates to a country and the geographic locations are cities located in this country; the regional intensity data indicates the ground shaking intensity caused in these cities; the weighting factors are based on population numbers of these cities; and the earthquake index indicates the impact of the earthquake event on the country's cities.

4. The system according to claim 1, wherein the interface module is further configured to receive risk values associated with the geographic locations, a risk value being indicative of a property value being at risk in a respective geographic location, and to determine the weighting factors based on the risk values associated with the geographic locations.

5. The system according to claim 1, wherein the location information relates to the earth and the geographic locations are the populated areas of the earth; the regional intensity data indicates the ground shaking intensity caused in the populated areas; the damage calculator is configured to determine the damage as a set of population numbers, each population number in the set indicating the number of people exposed to one of several defined levels of ground shaking intensity in the populated areas; the weighting factors are based on the defined levels of ground shaking intensity; the indexing module is configured to determine the earthquake index by adding up the number of people exposed in the populated areas to the defined levels of ground shaking intensity, the number of people being in each case weighted with the respective weighting factor; and the earthquake index indicates the impact of the earthquake event on the earth's populated areas.

6. The system according to one of claims 1 to 5, further comprising a financial instrument module configured to determine for a financial instrument associated with the geographic locations a financial payout based on the earthquake index.

7. A computer-implemented method of determining an impact of an earthquake event, the method comprising:
receiving and storing location information associated with geographic locations;
receiving via a communications network from an earthquake data server regional intensity data, indicative of ground shaking intensity caused at the geographic locations by the earthquake event;
determining an average damage expected at the geographic locations as a function of the ground shaking intensity;
storing weighting factors assigned to the geographic locations; and
determining an earthquake index indicative of the impact of the earthquake event, by adding up the damage expected at the geographic locations, the damage expected at each geographic location being weighted with the weighting factor assigned to the respective geographic location.

8. The method according to claim 7, wherein the weighting factors are based on population numbers associated with the geographic locations.

9. The method according to claim 7, wherein the location information relates to a country and the geographic locations are cities located in this country; the regional intensity data indicates the ground shaking intensity caused in these cities; the weighting factors are based on population numbers of these cities; and the earthquake index indicates the impact of the earthquake event on the country's cities.

10. The method according to claim 7, wherein the method further comprises receiving risk values associated with the geographic locations, a risk value being indicative of a property value being at risk in a respective geographic location; and the weighting factors are determined based on the risk values associated with the geographic locations.

11. The method according to claim 7, wherein the location information relates to the earth and the geographic locations are the populated areas of the earth; the regional intensity data indicates the ground shaking intensity caused in the populated areas; the damage is determined as a set of population numbers, each population number in the set indicating the number of people exposed to one of several defined levels of ground shaking intensity in the populated areas; the weighting factors are based on the defined levels of ground shaking intensity; the earthquake index is determined by adding up the number of people exposed in the populated areas to the defined levels of ground shaking intensity, the number of people being in each case weighted with the respective weighting factor; and the earthquake index indicates the impact of the earthquake event on the earth's populated areas.

12. The method according to one of claims 7 to 11, wherein the method further comprises determining for a financial instrument associated with the geographic locations a financial payout based on the earthquake index.

13. A computer program product including computer program code means for controlling a computer such that the computer
receives and stores location information associated with geographic locations;
receives via a communications network from an earthquake data server regional intensity data, indicative of ground shaking intensity caused at the geographic locations by the earthquake event;
determines an average damage expected at the geographic locations as a function of the ground shaking intensity;
stores weighting factors assigned to the geographic locations; and
determines an earthquake index, indicative of the impact of the earthquake event, by adding up the damage expected at the geographic locations, the damage expected at each geographic location being weighted with the weighting factor assigned to the respective geographic location.

14. The computer program product according to claim 13, comprising further computer program code means for controlling the computer such that the computer receives and stores location information related to a country and associated with cities located in this country; receives from the earthquake data server regional intensity data, indicative of ground shaking intensity caused in these cities; determines the weighting factors based on population numbers of these cities; and determines an earthquake index indicative of the impact of the earthquake event on the country's cities.

15. The computer program product according to claim 13, comprising further computer program code means for controlling the computer such that the computer receives risk values associated with the geographic locations, a risk value being indicative of a property value being at risk in a respective geographic location, and determines the weighting factors based on the risk values associated with the geographic locations.

16. The computer program product according to claim 13, comprising further computer program code means for controlling the computer such that the computer determines for a financial instrument associated with the geographic locations a financial payout based on the earthquake index.

17. A computer system for determining an impact of an earthquake event, the system comprising:
a data receiver configured to receive via a communications network from an earthquake data server regional intensity data, indicative of ground shaking intensity caused by the earthquake event in populated areas;
a damage calculator configured to determine a damage expected as a set of population numbers, each population number in the set indicating the number of people exposed to one of several defined levels of ground shaking intensity in the populated areas; and
an indexing module configured to determine weighting factors based on the defined levels of ground shaking intensity, and to determine an earthquake index indicative of the impact of the earthquake event, by adding up the number of people exposed in the populated areas to the defined levels of ground shaking intensity, the number of people being in each case weighted with the respective weighting factor.

18. A computer-implemented method of determining an impact of an earthquake event, the method comprising:
receiving via a communications network from an earthquake data server regional intensity data, indicative of ground shaking intensity caused by the earthquake event in populated areas;
determining a damage expected as a set of population numbers, each population number in the set indicating the number of people exposed to one of several defined levels of ground shaking intensity in the populated areas;
determining weighting factors based on the defined levels of ground shaking intensity; and
determining an earthquake index indicative of the impact of the earthquake event, by adding up the number of people exposed in the populated areas to the defined levels of ground shaking intensity, the number of people being in each case weighted with the respective weighting factor.

19. A computer program product including computer program code means for controlling a computer such that the computer
receives via a communications network from an earthquake data server regional intensity data, indicative of ground shaking intensity caused by the earthquake event in populated areas;
determines a damage expected as a set of population numbers, each population number in the set indicating the number of people exposed to one of several defined levels of ground shaking intensity in the populated areas;
determines weighting factors based on the defined levels of ground shaking intensity; and
determines an earthquake index indicative of the impact of the earthquake event, by adding up the number of people exposed in the populated areas to the defined levels of ground shaking intensity, the number of people being in each case weighted with the respective weighting factor.
